(19) United States
(12) Patent Application Publication
(10) Pub. No.: US 2012/0236900 A1
(43) Pub. Date: Sep. 20, 2012

(54) Time Temperature Monitor

(76) Inventors: Arnold Glynn Hubbard, Hertfordshire (GB); Brian Sagar, Cheshire (GB); Blue Ramsey, Devon (GB); Michael O'Connor, Berkshire (GB); John Davison, Surrey (GB); Sarah Davison-Poltock, Surrey (GB)

(21) Appl. No.: 13/381,073

(22) PCT Filed: Jun. 24, 2010
(86) PCT No.: PCT/GB2010/001246

§ 371 Date: May 8, 2012

(30) Foreign Application Priority Data
Jun. 24, 2009 (GB) 0910916.6
Jul. 13, 2009 (GB) 0912152.6

(51) Int. Cl. G01K 3/04; B05C 13/00; B05C 11/00; B23P 17/04

(52) U.S. Cl. 374/102; 29/428; 118/500; 118/642; 374/E03.004

(57) ABSTRACT

The present invention relates to a printed elapsed time-temperature indicating labels and to a method of indicating the elapse of a predetermined period of time and/or temperature. More' specifically the present invention relates to a device that measures and visually indicates the passage of a predetermined period of time and the various components of which can be formed by inexpensive printing methods and by lamination of one or more printed layers, which can be activated at point of use. The present invention is intended to provide a solution to the longstanding problems of providing an indication of the exposure of foodstuffs to unacceptable time and/or temperature conditions. In accordance with a first aspect of the invention, there is provided an elapsed time indicator comprising a liquid reservoir, a migration medium and a trigger; wherein the liquid reservoir is operable to release a liquid upon activation of the trigger into the migration medium, wherein the extent of absorption of the liquid from the trigger area can be determined by a change in colour or brightness of the migration medium and is an indication of one or both of differences in temperature and a passage of time.

### FIELD OF THE INVENTION

The present invention relates to printed elapsed time-temperature indicating labels and to a method of indicating the elapse of a predetermined period of time and/or temperature. More specifically the present invention relates to a device that measures and visually indicates the passage of a predetermined period of time and the various components of which can be formed by inexpensive printing methods and by lamination of one or more printed layers, which can be activated at point of use.

### BACKGROUND

It is common for food manufacturers to place expiration dates on food packaging in an attempt to provide an indication of the useful life of the foodstuff. The provision of such dates, however, is dependent upon the storage of such foodstuff under proper conditions, or at least within an estimated range of conditions. In addition, many manufacturers place “sell-by” dates, rather than expiration dates, on food packaging. Sell-by dates provide even less indication of the useful life of a foodstuff, since consumers may assume that the foodstuff remains useable for some time period following the sell-by date. Equally there has been the provision of “use-by” dates to overcome such uncertainty, although it still remains the case that many foods which are of satisfactory quality are discarded prematurely.

Both expiration and sell-by date indications become irrelevant if the foodstuff is exposed to temperatures higher than expected during the time period prior to the printed expiration or sell-by date. In such a case, the food item may have been exposed to spoiling temperatures prior to the marked date, but there may be little indication of any such exposure. However, the retailer or consumer would be misled into thinking the foodstuff was still acceptable.

Time and/or time-temperature indicating labels may be used in food manufacturing industries to identify food freshness. Time indicating labels may also be used where the label indicates a period of time has expired, such as sometimes the case with visitor badge labels. It has long been known to manufacturers and distributors that the shelf life of perishable goods such as foodstuffs is a function of both the time and the temperature at which such goods are stored.

To be useful, a time-temperature indicating label should provide its indication of expiration at approximately the same time as the food is expected to no longer be acceptable. Different foodstuffs have different tolerances for exposure to higher than normal temperatures. Thus, it is necessary to adjust the rate at which the time-temperature indicating label changes colour or otherwise indicates that an unacceptable time or temperature has been reached. It is desirable to be able to make such adjustments while changing a minimum of the manufacturing parameters and while maintaining a consistent product, in appearance, usability and function. Similar considerations apply in the pharmaceutical, chemical and other industries, where products are liable to deteriorate over time.

Many devices are known for measuring and displaying the elapse of predetermined periods of time such as hour glasses, mechanical stop watches, electronic stop watches, and liquid-diffusion time indicator devices. It will also be appreciated that there are concurrent requirements for timers in other industries, such as manufacturing, service and health care. One such example is in health care, where various components in a catheter arrangement (filters and the like) need to be replaced within a specified period of time. Keeping track of such time segments can be confusing and can lead to errors and oversights by working staff.

Thus, there has been a long standing need for a time-temperature indicating label and for labels that provide accurate freshness indicators that adhere directly to the packaging of time critical produce, such as fresh or frozen food packaging, for clear, visual monitoring of product shelf life. There is a need to monitor and indicate time-temperature exposure of food, so that both merchants and consumers can be assured the food has been stored and refrigerated properly prior to sale and/or use. It is well known that food degrades faster at higher temperatures than at lower temperatures, and that the time of exposure to such higher temperatures strongly relates to the degree of degradation resulting from such exposure.

A number of devices have been proposed for use as a time-temperature indicating label. However, many of these devices suffer from defects such as being unduly complicated or expensive to manufacture, or the device itself is subject to degradation over time and temperature exposure. Additionally, the fact that one or two experimental devices can be made is not the best way to determine an easy to set-up system for production of labels or such label devices. It is recognised that rather than manufacturing individual devices, mass production techniques favour reel to reel production.

WO 2008107871 (A1) provides an advertising device provided with a first area containing advertising indicia and a second area provided with a plurality of indicia display areas, wherein each indicia display areas is associated with indicia activation means undergoing activation at predetermined elapsed times relative to each other and wherein the display of all of the indicia in their designated indicia display areas provide a predetermined unitary message and wherein each of the predetermined elapsed times is, say, at least one hour in duration.

US2007064541 provides an electronic printed chromatic elapsed time indicator device comprising a switch, a power source and a power driven elapsed time display for indicating the elapse of a limited predetermined segment of time upon activation of the switch and irrespective of the actual time of activation thereof, wherein the components are functionally interconnected and are printed on at least one substrate.

U.S. Pat. No. 6,335,692 provides a visual indicator for a medication container operable to indicate to a user that a medication has previously been taken within a prescribed preceding time interval and should not be taken again. A substrate with a permissive symbol or indicator printed thereon is covered by a liquid crystal display which is comprised of a series of separately activated display segments which, when activated, block visual observation of the permissive indicator. When the container is opened and closed, initially all such display segments are activated, thus blocking or obscuring the permissive indicator. As the prescribed time interval passes, the successive display segments are sequentially deactivated, and when the prescribed time interval has expired, all such display segments are deactivated so that the permissive indicator is fully exposed to observation.

EP1688805 provides a system for monitoring a time sensitive medical product includes a medical product; a packaging containing the medical product; and at least one label associated with the packaging or the medical product. The at least one label includes at least one permanent region having permanent indicia; at least one transformable region having time sensitive indicia wherein the time sensitive indicia is non-detectable in a first state and detectable in a second state; a micro-controller operatively connected to at least one of the at least one permanent region and the at least one transformable region, wherein the micro-controller monitors elapsed time.

### OBJECT TO THE INVENTION

The present invention is intended to provide a solution to the long-standing problems of providing an economically viable indication of the exposure of foodstuffs and pharmaceuticals to unacceptable time and/or temperature conditions.

### STATEMENT OF INVENTION

In accordance with a first aspect of the invention, there is provided a time-temperature indicator comprising a liquid reservoir, a migration medium and a trigger; wherein the liquid reservoir is operable to release a liquid upon activation of the trigger into the migration medium, wherein the extent of absorption of the liquid from the trigger area can be determined by a change in colour or brightness of the migration medium and is an indication of one or both of differences in temperature and a passage of time;

wherein the migration medium comprises a planar medium which absorbs the liquid and wherein a migration path is defined by ultraviolet cured compounds within the migration medium, being bounded on first and second major surfaces by first and second impermeable media respectively laminated on first and second major surfaces of the migration medium, a migration channel being defined within the migration medium by the application of impermeable ink, at least one of the impermeable media being transparent such that a change in colour or brightness can be determined, as between a trigger area of the migration path and a distal portion of the migration channel, the channel being bounded by impermeable media compounds that minimise surface tension effects as between the indicator fluid, the walls of the channel and the wicking medium to affect the indicator fluid flow. That is to say, with regard to any particular choice of indicator liquid, surface tension effects as between the indicator liquid, the walls of the channel and the migration medium do not affect the passage of indicator liquid to any material extent.

The fluid reservoir can comprise a sachet of liquid, which is placed or positioned adjacent a trigger portion of the indicator, the sachet being arranged to release the indicator liquid upon the application of excess pressure, whereby to cause the liquid to be absorbed by the migration medium.

Conveniently, the migration channel or path vents to the atmosphere. The liquid reservoir can be located on a face of one of the impermeable media and adjacent an area of the impermeable medium which is of a frangible nature whereby to enable passage of the liquid from a first side of the impermeable medium to the migration medium upon activation of the indicator. Each impermeable medium is attached to a respective side of the migration medium by impermeable adhesive.

The migration medium is preferably selected from one of paper, felt, cellulose fibre or synthetic material with porous microstructure. The activation means can comprise a pressure-rupturable seal, a heat-rupturable seal or an electrically-rupturable seal between the reservoir and the trigger area of the migration medium.

Preferably, the properties of the liquid and the migration medium are selected so that migration along the migration medium covers a predetermined time period within a narrow temperature range.

The present invention thereby provides a label format that is reliable to use yet cheap to manufacture, that readily assists in the maintenance of food and pharmaceutical quality and safety. Equally specific applications exist in the transport of organs, blood, vaccines, flowers and in the sale and preparation of food, medicine, agriculture and horticulture generally

The present invention provides smart labels that allow processors and distributors to track food freshness in transit and in storage, saving the expense and potential health hazard caused by spoiled or wasted food.

The present invention thus provides a new type of time-temperature label which can be provided with several types of indicator liquid, operable to indicate the elapse of time and or change of temperature to a particular value. The present invention can be conveniently produced using variations of printing techniques and using suitably adapted print machinery. The system lends itself to computer controlled manufacture, whereby to reduce production costs and meet anticipated levels of demand for the products.

The new method of construction has provided enhanced activation and also allows conductive fuses to be used, thereby offering a much greater opportunity for the development of non-mechanical activation.

In one aspect, the invention comprises the use of a uv curable plastics substance (ink/adhesive) which, when introduced into a paper base, can define channels in such paper base. Since this can be utilised within a number of paper thicknesses and have a number of channel lengths, then rates of diffusion can be varied for particular circumstances. The use of an ultra-violet curing ink/glue enable a high definition of channels or paths within the migration medium to be obtained; by the appropriate use of a uv curable ink/glue, then the time to set can be in the region of 0.2-2 seconds, which facilitates prompt processing in manufacture and no time for liquids to spread or deviate from their design dimensions. Further more, especially in the manufacture of the channels, the de-wicking fluid can be printed easily, and promptly cured, whereby reliable printing to a high definition is economically provided at high quality.

In another aspect the present invention comprises a number of chemicals, which can be selected to provide a rate of diffusion which can be tailored to any one of a number of time/temperature situations.

### BRIEF DESCRIPTION OF THE FIGURES

For a better understanding of the present invention, reference will now be made, by way of example only, to the Figures as shown in the accompanying drawing sheets, wherein:—

FIG. 1a illustrates the outward appearance of a first label in accordance with the invention;

FIG. 1b illustrates a view of an underside of a label, post activation, in accordance with the invention;

FIGS. 2-8 detail steps involved in the manufacture of a label in accordance with one embodiment of the present invention;

FIG. 9 shows a first type of trigger;

FIG. 10 shows a perspective schematic view of a sachet-forming stage for manufacturing a label in accordance with the present invention;

FIG. 11 shows a perspective view of a prototype sachet-forming unit with control gear attached;

FIGS. 12 a-12 d show linear plots of t vs d² (where d is the distance the liquid front moves in time t) at temperatures 4° C., 7° C., 10° C. and 13° C. respectively for a system in accordance with the present invention; the slopes of the regression lines give the rates of diffusion (wicking) at each temperature;

FIG. 13 shows the Arrhenius plot of the natural logarithm of the rates of diffusion (wicking) vs. the reciprocal of the absolute temperature, providing an estimate of Ea, the energy of activation of the system;

FIG. 14 depicts plots of time (for the liquid front to traverse a distance of 12, 19 and 23 mm) vs. temperature for a particular label modelled in accordance with the invention; And,

FIG. 15 shows two time temperature labels made in accordance with the present invention.

### DETAILED DESCRIPTION OF THE PREFERRED EMBODIMENTS

There will now be described, by way of example only, the best mode contemplated by the inventors for carrying out the present invention. In the following description, numerous specific details are set out in order to provide a complete understanding to the present invention. It will be apparent to those skilled in the art, that the present invention may be put into practice with variations of the specific.

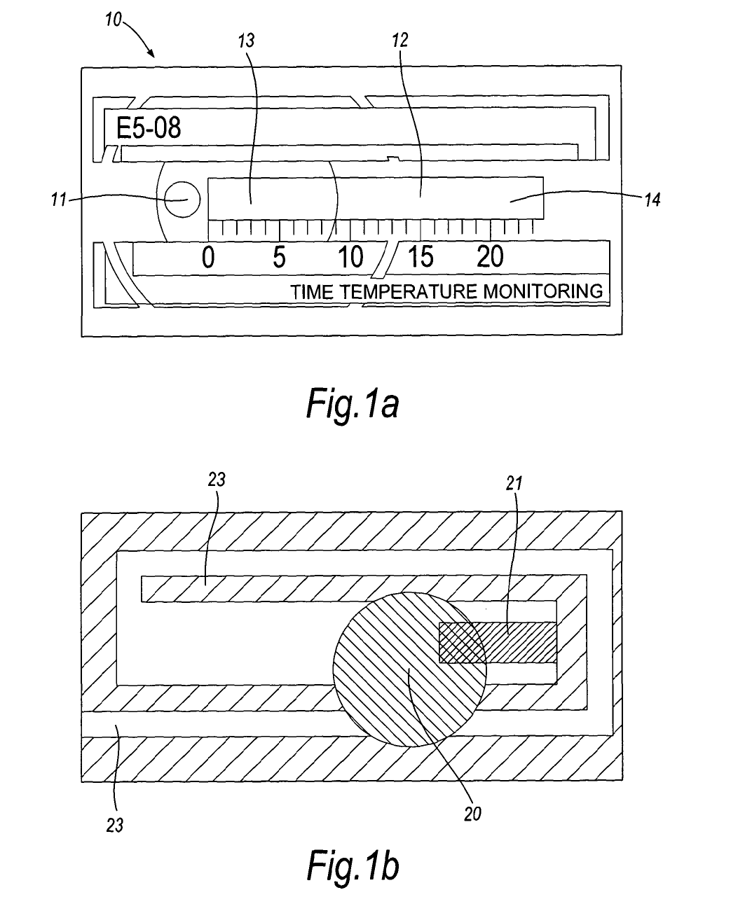

FIG. 1a refers to a first example of a time-temperature label made in accordance with the invention. The label 10 is shown as would be seen, attached to a product with a time-temperature-dependent life-expectancy as is the case with many products of commerce in the food industry, medicines, chemicals and the like. The front face of the label has a first indicator 11 which is coloured, for example red, indicating that the label has been activated. Further visible portion 12 is provided in white, with the coloured liquid providing an indication of a passage of time 13, with reference to a scale 14, the scale spacing need not necessarily be geometrically spaced apart. In this instance, an indication of a time/temperature limit having been exceeded is provided by a circle indicator being of a different colour, but there are many possible options to provide an indication of a particular time/temperature limit having been exceeded. In use there is a diffusion liquid reservoir that is punctured so that it releases the liquid to an initial zone—which changes colour to indicate that the label has been activated.

The label may be provided with certain time indicators, for example, associated with a time temperature monitor for a temperature sensitive product which is subject to extreme and unacceptable variations in temperature in, for example, a lorry-airplane-train lorry delivery cycle. If there are provided portions of the monitor which have acceptance windows, then if a time indication fluid is present or not present in an acceptance window at any one stage of a delivery cycle, then the product may be correctly rejected and not allowed to go on sale or allowed to move for further distribution if, typically, the indicator had passed its acceptance window, for example because of an unacceptable increase in temperature or by reason of delay in forwarding from a base.

FIG. 1b shows a reverse face of the label, with the generally circular area 20 indicating an area wherefrom the diffusion liquid is released via trigger/release means 21. The rectangular spiral pattern 22 determines the flow path of the wick to the atmosphere at the opening indicated by reference 23: the wick-path for the diffusion liquid comprises a number of paths, each adjacent length being joined by a right-angle corner, indicated by numerals. In use the diffusion liquid reservoir is punctured so that it releases the liquid to an initial zone—which changes colour to indicate that the label has been activated. As will be appreciated the diffusion path is as long as required for a particular situation. It may be that the length may only need to be as long as the time temperature label; it may need to be several times this length: the channel may be serpentine-like in shape—rather than zig-zag, where the sharp turns may not provide consistent results.

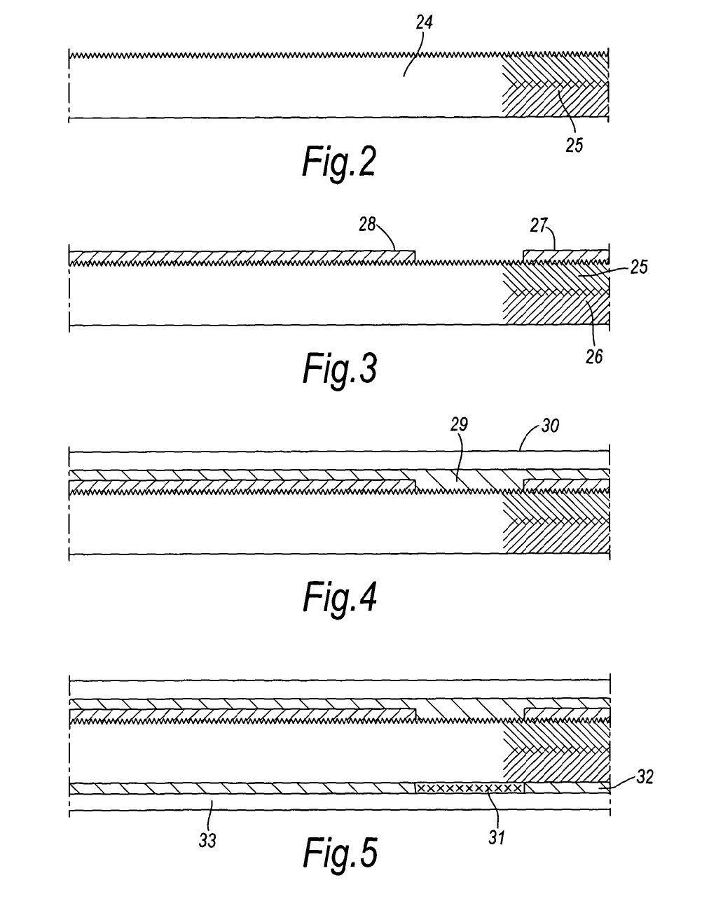

Reference shall now be made to FIGS. 2-8 which show the basic steps involved in the production of a label in accordance with the invention. In the first instance, and with specific reference to FIG. 2, a paper (the sheet migration medium) with a high uniformity of construction, where the paper is composed of fibres of uniform diameter and length to ensure good uniformity of the size of the capillaries between the fibres, is employed as a base material along which an indicator liquid can flow; the pattern along which the indicator fluid can permeate is defined by printing a pattern for the flow of fluid employing impermeable ink—which acts as a glue or sealant to define the walls of the migration path or channel. The section shown in this figures does not show the plan view of the indicator pattern which could comprise a path that is rectilinear, curved or serpentine in nature, although sharp edges of transition at corners are preferably avoided. The path for the indicator fluid is defined leading to the atmosphere; the path is not closed at both ends, since it has been found that the provision of the channel having an end open to atmospheric pressure assists in the operation of the device, since no build up of gaseous pressure can occur whereby to affect the rate of migration of the fluid along the channel defined within the migration medium. If there is a pressure differential across the ‘front’ the run out times will be affected, moving the observed results from the theoretical results. Having the wick open to atmosphere at one end reduces pressure differential.

The pattern for allowing the flow of the indicator liquid is created by applying an ink comprising a de-wicking substance (25 and 26), applied, conveniently by way of a printing mechanism onto a diffusion medium, conveniently paper. In the case of a thick medium, it may be required that the de-wicking fluid is applied from both sides 25 & 26; preferably it applied only from a first side 25. That is to say the flow path or migration path is delineated by a channel defined by an adhesive ink that sets. The de-wicking material is, for example, a polymer which is applied as a liquid which is then set upon application of ultraviolet (UV) light, the UV light being applied as soon as the ink has been laid down, whereby to ensure good pattern definition. Applicants have determined that screen printing procedures can be employed; in one stage, with the application of sufficient force, the de-wicking liquid can be printed upon the surface of the paper whereupon it rapidly diffuses through the paper thickness with minimum lateral diffusion; upon removal of the screen of the screen printing process, then UV light can be immediately directed upon the paper to cross-link the UV-curable system. The process time can be as short as 1 second, with as many as 150 time-temperature devices being printed upon an area of paper sheet around 1350 cm²; in process time, eight frames can be completed per minute, including the placement and alignment of each sheet of diffusion medium. Speeds will vary with thickness of diffusion medium. Thick (>150 gsm) sheets of paper will be less able to prevent diffusion of fluid divergent to the intended direction, being normal to the planar surface of the sheet paper. In the alternative, less preferred process, using other conventional printing procedures, it has been found, in order to reduce spread of the wicking fluid in the plane of the paper, that the de-wicking compound is applied from both sides, with the smooth side of the paper being treated in a second passing, below.

The de-wicking compound can be conveniently applied as a liquid and is ultra-violet light cured whereby to enable simple and convenient control of the setting process. One reason for this is the ink can be formulated with 100% solid content (that is, without a solvent) so that there is no shrinking or formation of voids, since there are no volatile ink-components, and greater degree of control are offered to the operator. The rheology and functionality of such a UV ink is important to ensure it is absorbed into the fibers of the paper in a controlled manner i.e. if the viscosity is too thin then it will flow into the printed de-lineated wick by way of a capillary effect. A significant further advantage is that with uv inks effectively instant curing is provided. In the manufacture of the ink, the three key ingredients are oligomer (resin), monomer (thinners) and a structuring agent. It is believed that by providing short oligomer chains, then the_ink can flow through the paper fibres but with minimum sideways diffusion; in contrast, if they were too long, then they would be prevented from easily passing throughout the thickness of the paper resulting in incomplete blocking. Indeed, the resultant flow diffusion paths have walls substantially perpendicular to the planar surface of the paper sheets.

Two types of ink can conveniently be employed. One is an aliphatic trifunctional urethane, useful for clear as well as pigmented formulations, which can be provided to be applied upon flexible plastic substrates, paper and metals. The second preferred ink is ethoxylated (3) phenol monoacrylate, flexibilizer, which is conveniently applied for UV curable litho, screen and flexographic inks, clear litho coatings, and lacquers. The ink in accordance with the invention may be employed effectively, as an adhesive or glue in certain of the printing processes, with a primary function not being graphic.

In FIG. 3, layers 27, 28 represent ink as applied in graphic style over the time-temperature label. It is important that this ink is not absorbed into the top surface of the migration medium and like the adhesive 29 effectively seals the top surface of the migration medium, extending over the de-wicked portions, whereby to define channels—FIG. 5 describes the process on the second or underside of the migration medium. Next an ultra-violet cured polyester adhesive 29 is applied to a thickness of the order of tens of microns, for example 10-20 microns, per FIG. 4. It will be appreciated that the labelling ink will not be applied all over the upper major surface of the migration medium since the migration path must be visible, at least to the extent necessary for determination of the time-temperature history of a product. The labelling ink and the adhesive ink must not be such that they are absorbed in to the migration medium. The labelling ink may be applied either prior to or subsequent to the application of the adhesive ink 29. Ultraviolet lamps can be used, conveniently the lamps being used in a number of passes, followed by a final coat of polyester film 30, conveniently applied as a separate film, rather than as a spray coating, care being taken to substantially eliminate voids due to the inclusion of bubbles; equally care is taken so that the atmosphere is dust free, since dust lying upon either the adhesive 29 or the polyester film will introduce blemishes which would, at best, look unsightly. As will be known to the skilled man, antistatic devices will be present; ventilation will ensure that the atmosphere shall be dust-free. The polyester film is the final layer of the outermost side of the label.

It has been found that if the paper has a rough face and a smooth opposite face, then it is advantageous to apply the de-wicking fluid to the rough edge first. In tests it has been found that an 80 g weight paper such as Sappilene 80 gsm provides a uniform grade of paper that is suitable for indicators.

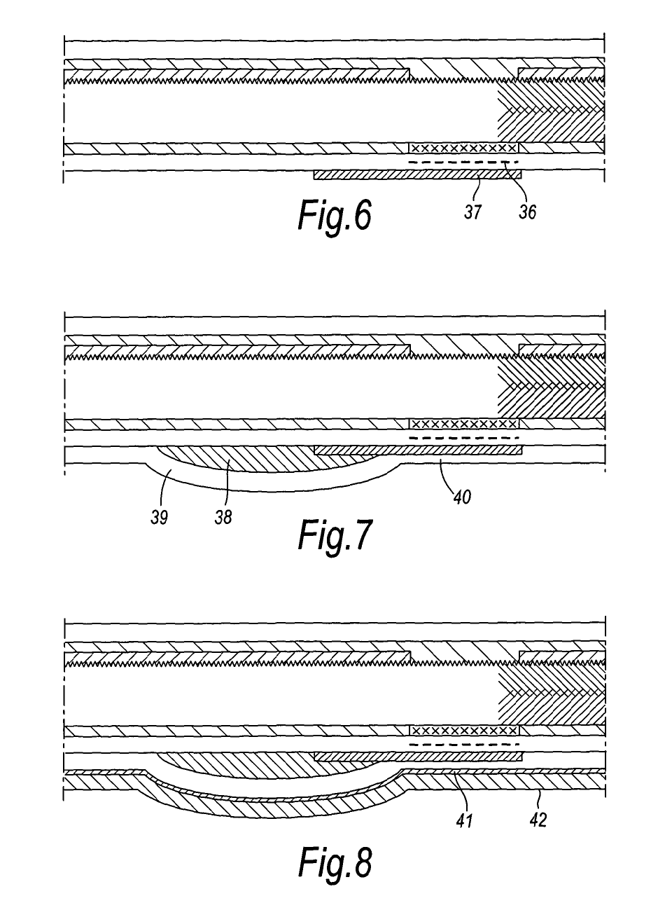

The second side shall now be discussed in relation to FIGS. 5-8. Specifically with reference to FIG. 5, Layer 32 provides a patterned film of UV-curable adhesive, which is applied over the whole area of each individual label to a thickness of fifty microns except for the provision of a small area 31 which is associated with the transfer of the diffusion liquid from an initiating reservoir of fluid on the other side of the diffusion track, as will be discussed below. Layer 33 is a polyethylene film which has a surface 36 which is perforated adjacent to the region of area 31, per FIG. 6—the perforations are conveniently created by a kiss-cut knife arrangement to a depth sufficient to penetrate the polyethylene film (layer 33), but not sufficient to pass through the label substrate material (layer 24). A low adhesion ink 37 is then applied to the area of the polyethylene whereby to seal the perforations of the polyethylene film. Alternatively an ink based barrier may be used without the polyethylene.

Referring now to FIG. 7, an indicator-liquid sachet 38 is created and is retained by the application of a heat laminated film of polyester 39. FIG. 8 shows a layer of pva copolymer label adhesive 41 which is then applied onto the polyester, followed by the application of a protective backing paper 42. Conveniently, this procedure is performed on large sheets of paper whereby to produce multiple monitor labels which can then be cut in a die board operation/laser trimming operation or the like, whereby the labels can either be separated or joined, for example by the backing sheet only. Equally the labels may be cut into linear strips, being retained by the backing paper and as such would be suitable for the automated application of such labels in a manufacturing plant.

The manufacturing operation shall now be described in more detail. Ink may be applied, in relation to the printing of labelling indicia, on either side, prior to or after the application of an adhesive, both the adhesive and labelling ink being able to seal a top surface of the channels, but not affect the performance of the indicator ink as it passes through the migration channel, care being taken so that adhesive is not applied in the region of the activation trigger of the device, on the side to which the reservoir is to be located and that the progress of the indicator fluid as it progresses along the migration path can be seen. Lamination to each side of the device is then performed; with the use of an impermeable plastics material in relation to the fluid to be contained within the reservoir. An ultra-violet cured polyester adhesive 29 is applied to a thickness of the order of tens of microns.

It has been determined that the ink is formulated as a UV ink, whereby it is cured by the application of ultraviolet light. One reason for this is the ink can be formulated with 100% solid content so that there is no shrinking since there are no volatile ink-components, and greater degree of control are offered to the operator. The rheology and functionality of such a UV ink is to absorb into the fibers of the paper in a controlled manner i.e. if the viscosity is too thin then it will flow into the de-lineated wicking channels being printed by way of a capillary effect. A significant further advantage is that with uv inks effectively instant curing is provided. In the manufacture of the ink, the three key ingredients are oligomer (resin), monomer (thinners) and a structuring agent.

Ultraviolet lamps are used, conveniently the lamps being used in one or more passes, followed by a final coat of polyester film 30, conveniently applied as a separate film, rather than as a spray coating, care being taken to substantially eliminate voids due to the inclusion of bubbles. Equally care is taken so that the atmosphere is dust free, since dust lying upon the either the adhesive 29 or the polyester film will introduce blemishes which would look unsightly. As will be known to the skilled man, antistatic devices will be present; further ventilation will ensure that the atmosphere shall be effectively dust-free. The polyester film is the final layer of the outermost side of the label.

Effectively, the provision of the de-wicking fluid, which then sets to prevent fluid flow in the plane of the migration medium corresponds to the “sides” of a channel for the flow of the fluid to occur in a particular direction, with the first and second impermeable layers providing the “floor” and “roof” to the channel. The channel can be effectively of any shape; the shape could correspond to a word; as the indicator changes more and more of the migration medium will indicate, the indicator colour, which is ordinarily chosen to be a contrasting colour whereby the temporal change is easily determined. However, it may be that a colour indication of contrasting colours may cause alarm and the preferred indicator change may comprise a reduced reflectance, although the change would still be noticeable.

In the region of the trigger, where no adhesive has been applied, a low-adhesion ink is applied followed by the cutting of a number of kiss-cuts, with several lines of approximately 2 mm spacing across the region of the trigger region. This has been found to provide an easily manufactured pressure-ruptured trigger. It will be appreciated that this step is not necessary if, for example, an electrical inductively heated trigger is employed.

The action of the time-temperature label in accordance with the invention shall now be discussed. The liquid indicators pass through the paper by capillary action, which is controlled for a given paper mainly by the viscosity of the liquid indicator, with its surface tension having a secondary effect. The rate of diffusion is directly related to the fluidity (i.e. reciprocal of viscosity) and surface tension of the indicator liquid. The viscosity of a liquid is governed by its molecular structure. Different compounds cover a range of viscosities over several orders of magnitude. By carefully choosing the appropriate compound as indicator liquid it is possible to meet the requirements of any time/temperature situation. Since the viscosity of any given compound is inversely proportional to its temperature, it is furthermore possible to mimic the activation energy of the degradation process of concern (such as microbiological or oxidative degradation of foodstuffs) by choosing a compound as indicator liquid with a closely similar activation energy of viscosity change with temperature.

Part of the manufacture of labels in accordance with the present invention requires specifically formulated liquids to be encapsulated within the label structure. The liquid has to remain contained between the impermeable film such as polyethylene barrier film adhered to the label substrate, and a polyester backed polyethylene composite ‘heat-seal’ backing film or overlying film until the device is activated via the trigger. The uv-curable ink, which defines the walls, together with the coated films in contact with the major planes of the diffusion flow sheet material are surface tension neutral in that they act so as to prevent surface tension effects from enabling a liquid to flow at a rate independent of the diffusion medium. This is a significant advantage in the control of the flow of the time temperature indicator liquid.

Depending on the job in hand, coverage of printing inks can be expected to be within the range 50-100 square metres per kilogram of ink. Accordingly, if we say 75 square meters to 1 Kg of ink, then 1.0 g of ink would cover approximately 0.073 m2 of diffusion paper.

Whilst it is possible to form sachets of liquid and have them placed within laminating plastics film, it has been found that the use of a heated roller with vacuum depressions to heat and retain an overlying plastics film over the reservoir face of the label, during manufacture, can be more accurately managed. Whilst there may be concerns regarding the flow of the liquid prior to full encapsulation, it has been found that by the use of fumed silica to thicken the liquid and/or the corresponding timely addition of an exact amount of fluid prior to sealing the sachets, perfect sachets can be formed on a continuous basis.

This above described sachet forming apparatus has been designed to form reservoirs to encapsulate these fluids, on a continuous web, forming the necessary seal at the nip between two rollers. This rotary machine has significant benefits over the more commonly used platen techniques, namely a greater control of the pressure and temperature in the roller nip, resulting in a more uniform and consistent seal. In addition it is potentially a more cost effective method as material can be processed at greater speeds.

The main unit feeds the materials to be processed, viz. the label substrate, the backing heat-seal film and the fluid. The two substrate materials are brought together between two temperature controlled, heated, rollers; one elastomer-sheathed to ensure uniform pressure, the other machined aluminium. The two films are pulled through the sealing rollers by a pair of driven, unheated elastomer-sheathed rollers. The machine enables direct control over all three factors determining the quality of the seal, pressure, temperature, and the duration for which they are applied.

Each reservoir is formed by prohibiting portions of the heat-seal backing material from contacting the label substrate as they pass through the roller nip. To enable this to take place the aluminium roller has been manufactured with a series of cavities in the surface, such that when a vacuum is applied the heat-seal material is sucked into the roller, and so does not seal with the label substrate. Control of the vacuum is critical to determine the volume of the sachet (for a given surface area) and to ensure that the laminated structure is not retained on the roller once it has passed through the nip.

Referring now to FIG. 11, there is shown a perspective view of a sachet forming machine. Lamination unit 1 has a roll of heat-seal material 2 which is applied to label substrate material 3. To ensure the sachets are positioned correctly on the substrate the machine has the ability to align automatically to each row of labels, enabling it to cope with tolerances inherent in the screen print process used for the manufacture of the label substrate—although it is to be understood that screen printing is not the only way of manufacturing such label or label devices. This alignment is achieved using an optical device to determine the leading edge of each label, whereupon the substrate feed is halted, the vacuum is turned off and the heated aluminium roller is lifted away from the substrate. As the roller reaches the top of its travel it's locating collar meshes with a pin causing the roller to rotate and realign if necessary.

Indicator liquid delivery is achieved through the use of a compressed gas or mechanical dispensing system, this delivers a pulse of air at a known pressure for a known duration to a manifold comprised of fluid filled dispensing syringes, of which there are fifteen in the example shown. The liquid is preferably fed into the ink fill portions by the use of a peristaltic pump, which can feed the empty sachets in a fashion whereby air pockets are absent and the dose is accurately measured, as will be known to those skilled in the art. In addition to control of the pressure and duration of the pulse, desired fluid flow can be achieved by modifying the rheology through the addition of nano-particulate silica, the selection of appropriate dispensing nozzles and if necessary (though not for this machine) through thermally controlling the manifold head. This dispensing system has proved very versatile and entirely practical for this application, enabling the type of liquid dispensed to be changed rapidly, and the quantity (around 10 μl) to be adequately controlled. The liquid is dispensed directly onto the label substrate, and then drawn with it through the sealing rollers. Control of the quantity of dispensed liquid indicator can be controlled by the degree of the vacuum used—created by vacuum pump 4, together with fluid dispensing controller 5, whereby to enable the volume of dispensed liquid to be closely matched to the volume of the sachet. A master control device ensures that the particular components operate synchronously. This figure does not show the liquid dispensing manifold.

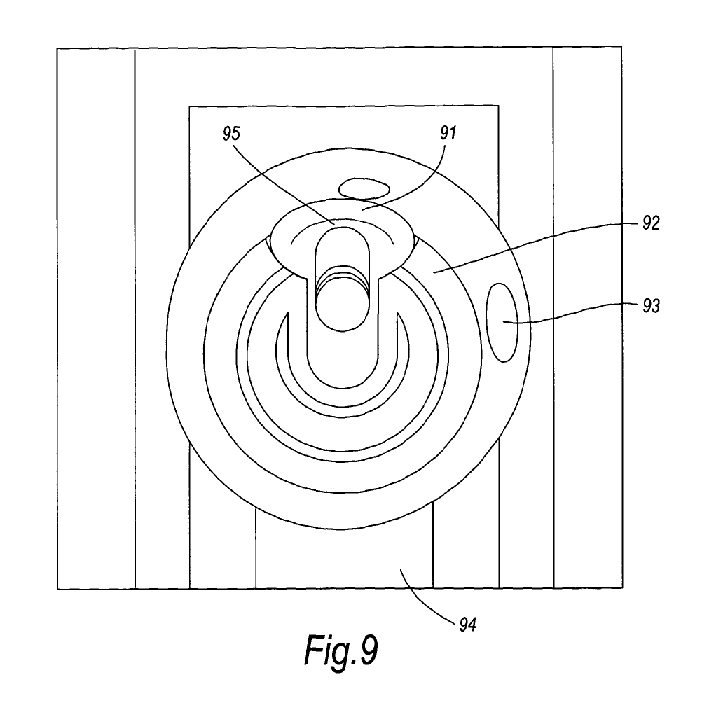

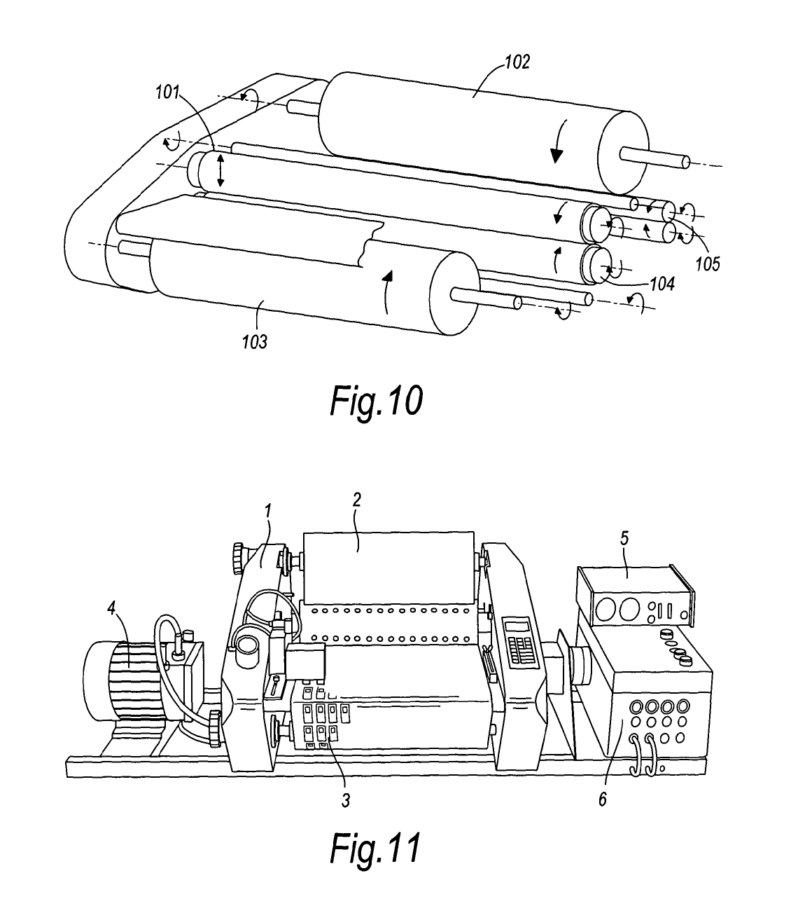

FIG. 9 shows a completed trigger device for initiating a timer in accordance with the present invention. Trigger element 95 is arranged to rupture the liquid reservoir formed on the screen-printed label substrate. Unsupported PE zone 91 enables melt hole formation; 92 shows the inductively coupled conductive fuse structure; 93 is an air pocket in the sachet fluid; 94 is the label run out wick, formed within the label substrate.

An alternative approach has been developed whereby the fuse can be printed directly onto the polyethylene and separated from the TTI liquid by this barrier film. This objective has been achieved by first supporting the polyethylene film on a temporary paper carrier coated with a dry-peel adhesive and then printing the fuse on the polyethylene before laminating it to the paper that will form the wick. The major breakthrough that allowed this approach was the development of a technique for blocking the paper in one step, after laminating to the polyethylene.

With this new method of constructing the ‘dry’ part of the TTI it is now possible to print a much larger fuse, thereby requiring lower inductive power input. It is anticipated that non-contact activation should be possible in the near future by this approach.

The present invention provides a diffusion controlled indicator which operates by having a wick, delineated in a paper layer, along which the TTI liquid upon activation can diffuse. A colorant is carried along the wick by the diffusing liquid. There is a reservoir of TTI liquid that comes into contact with one end of the wick on activation, which provides the ability for the liquid to “flow”. When frozen, there is no free liquid to diffuse along the wick. At constant temperature the rate of diffusion, k, equals d²/t, where t is the time taken for the diffusion front to move distance d from the origin.

Prior systems have operated in with reference to a Partial History Time-Temperature Indicators (PHTTIs) which indicate the time-temperature history experienced from their point of initial activation but only at temperatures above a Critical Reference Temperature (CRT). However, such devices incur problems in that many PHTTI liquids display significant differences between the melting and freezing temperatures of these compounds. This problem has been resolved by the use of Full History Time-Temperature Indicators (FHTTIs), which are liquid at all temperatures likely to be encountered during the storage of the product and they offer the possibility of monitoring the temperature history of products even when stored under optimum conditions.

Further, FHTTI compounds have the merit of continuing to integrate temperature fluctuations with time, even though there has been no temperature abuse. It will be appreciated that a data base of TTI compounds is required, with appropriate rates of diffusion/run-out times at various temperatures matching the requirements of a range of end-use storage requirements. In considering the development of new TTI liquids suitable for use in a wide range of FHTTIs, first and foremost any putative liquid must not represent any toxic hazard to the end user. Whilst accepting that the liquid is fully encapsulated within the structure of the TTI device, nevertheless selection of liquids for study has been largely confined to materials known to be acceptable as food additives.

Clearly, to be of practical value a liquid mustn't be antagonistic to any of the other constituents of the TTI such as the UV curing adhesives, the fuse barrier and blocking agents. Indeed, with some types of otherwise very useful liquids, typified by long chain aliphatic esters, slow diffusion through the polyethylene barrier film is another source of difficulty. Industry demands of shelf lives of un-activated TTIs are at least 12 months.

In order to be suitable for a particular application a FHTTI liquid must exhibit a run-out time at a given temperature that exactly corresponds with the proposed shelf life of the product being monitored, when stored isothermally at that temperature. Furthermore, the degree of change of rates of wicking/run-out times with temperature (the activation energy) should mimic, as far as possible, the activation energy of the most important degradation process of the product being protected.

Some 30 compounds were selected for initial screening. Rates of diffusion (wicking) of the most appropriate 10 compounds were measured at four sub-ambient temperatures in chilled cabinets controlled to better than +/−0.1° C. using blank labels and activating by cutting the polyethylene barrier film with a scalpel.

It was shown that the change of the rate of wicking with respect to temperature change is well modelled by the Arrhenius equation, as are many deteriorative processes in food products: In k=lnA−Ea/RT, where A is the Arrhenius constant, Ea is the energy of activation for the system, T is the temperature in degrees Kelvin, R is the universal gas constant and k is the rate constant. The Arrhenius constant and activation energy were computed for each of the 10 compounds and used to calculate the rates of wicking and run-out times at any given temperature.

Diffusion theory suggests that rate of wicking should be related inversely to the viscosity (v) of the TTI liquid and directly to its surface tension (S). It was shown from measurement of these two properties at four sub-ambient temperatures, for each of the 10 selected compounds, that both viscosity and surface tension are influenced by temperature according to an Arrhenius relationship. Derivation of A and Ea allowed viscosity and surface tension to be calculated at the same temperature as the calculated rates of wicking for all 10 compounds. From these data it was possible to demonstrate that a linear relationship exists between rate of wicking, k, and S/v.

Applicants have performed a study on a class of compounds, covering more than a one-hundredfold range of wicking rates at 7° C. It is understood to offer the opportunity to calculate rates of wicking over a range of temperatures to enable choices to be made of the most suitable compound for a given FHTTI end-use application. Furthermore, it has been established that rates of wicking can be calculated from independent viscosity/surface tension data. Additionally, a limited amount of work has been carried out with four PHTTI systems with CRTs between 7 and 8° C. for a specific end-use application.

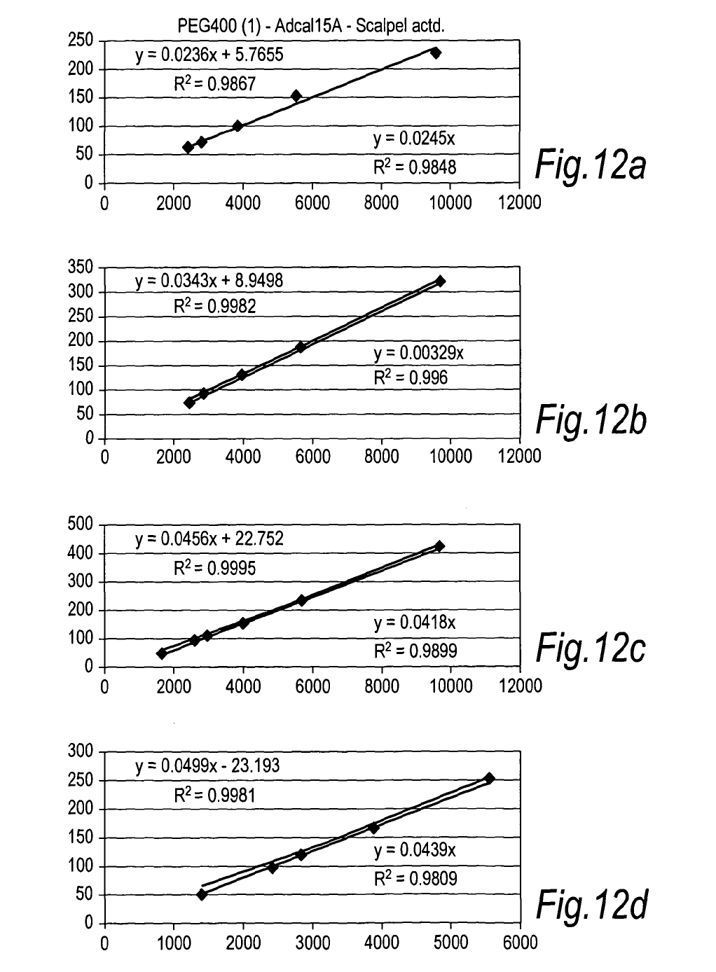

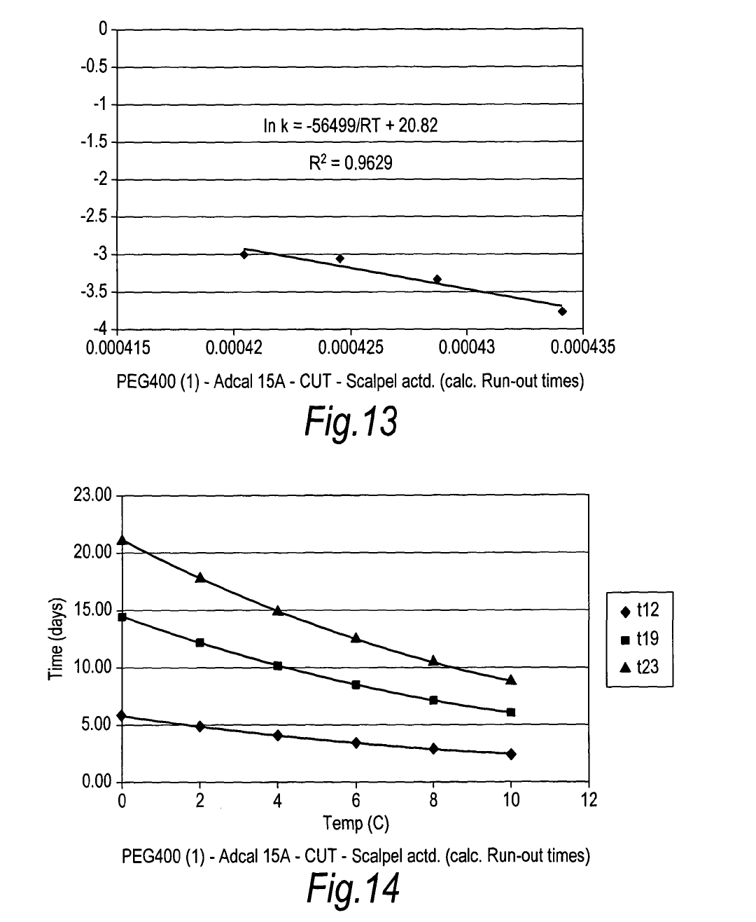

To assist in the understanding of the present invention, data relating to wicking flow has been represented graphically in three ways, with reference, in particular, to a liquid PEG400. PEG400, Polyethylene Glycol 400, is a low molecular weight grade of polyethylene glycol. It is a clear, colorless, viscous liquid which is soluble in water, acetone, alcohols, benzene, glycerin, glycols, aromatic hydrocarbons and is slightly soluble in aliphatic hydrocarbons. The first set of data relates to a range of isothermal plots showing linear relationships between time and the square of the distance moved by the TTI liquid, which provide values for the rate of movement of the liquid at each of four chosen temperatures. Two rate values can be derived at each temperature, depending on whether it is assumed the linear relationship passes through the origin, as shown on FIGS. 12a-d. The second set of data relates to the rates of diffusion (wicking) derived in this way can then be used to plot the change of rate with respect to temperature, as modelled by the Arrhenius equation, ln=lnA−Ea/RT, thereby providing an estimate of Ea, the energy of activation of the system, as shown in FIG. 13. The third set of data relates to the use of a derived value of Ea, the time to reach a given distance along the wick can be calculated for a range of different temperatures. Plots of time vs. temperature fall on smooth curves for each chosen distance from the origin, as shown in FIG. 14.

Applicants have determined that the rate of wicking (k) is related inversely to the viscosity (v) and directly to the surface tension (S) of the TTI liquid. FIGS. 12a-d of the set demonstrates that a linear relationship exists between k and S/v at any given temperature (7° C. for the data in FIG. 12a), covering more than a one-hundredfold range of wicking rates, thereby confirming that the rate of wicking can be calculated from independent viscosity/surface tension data.

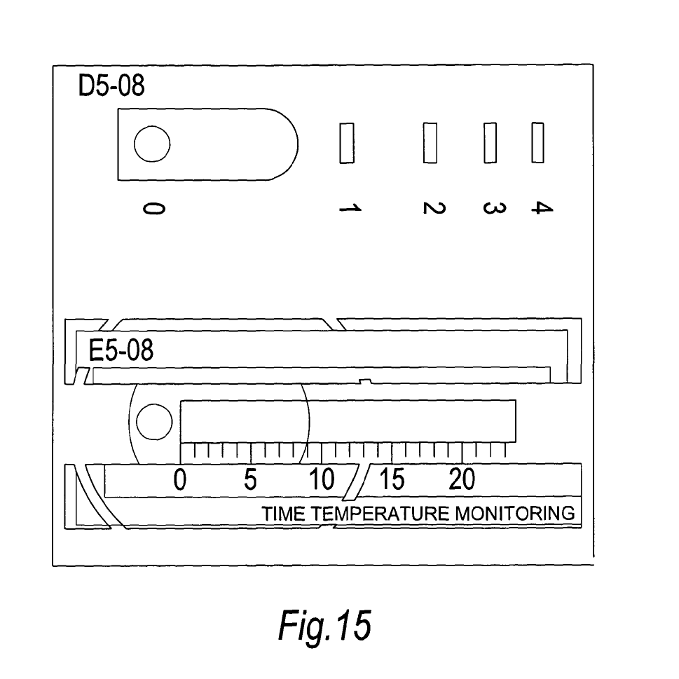

FIG. 15 shows two time temperature indicating labels in accordance with the present invention. In this particular case, the labels were initiated at the same time and reference 150 shows the “front” of the time temperature indicator; whereby to determine the time-temperature condition—as determined by the particular choice of liquid for the particular product.

The present invention provides a diffusion-based indicator of time which is easier to start and is provided with a more easily discernable identification of “maturity”; no batteries are required; it can be started independently of manufacture, the diffusion rate can be determined to suit packages.

Unlike conventional labelling which solely indicates the product expiry date, TTI labels enable any user to see clearly whether a product is within its date/temperature parameters and therefore safe to administer, consume etc. This is important information and a useful aid for patients, doctors and health-workers. For example, the TTI label can be employed to determine the integrity of a cold chain: TTI labels are calibrated to the lifetime characteristics of the product (from 4 hours to 12 months at room temperature, refrigerated or frozen) and to the degree of temperature/time sensitivity of the product.

A further benefit provided by labels in accordance with the invention is that they are validated at a point of use: TTI labels offer an intuitive visual check for healthcare workers to complement other important product data when administering vital pharmaceutical, vaccine or biological products. Further, TTI labels can assist in the confirmation of product authenticity and can also incorporate anti-counterfeiting measures to ensure product origin and authenticity.

The use of easy to read TTI labels can assist in compliance duties and can prompt nurses and or patients when repeat doses or procedures (e.g. dressing changes) should be administered. In other medical situations, a reduced wastage of product can result. For example, blood and blood products must be used within a short period of time after removal from a refrigerator. A visual label will prompt awareness of proper storage and, in a busy theatre or A&E unit avoid uncertainty leading to wastage of a valuable product.

A still further application of the present invention is in the provision of temperature time media such as papers for self-diagnosis testing as suitable for diabetic self-test kits, pregnancy tests and the like are wherein a blood sample or a urine sample defines a colour change path. By defining the path taken by a sample fluid, then less sample may be used or the time taken could be reduced; in such tests, a reduction in time from, for example, 10 minutes to 5 minutes would be greatly appreciated by diabetics or expectant mothers alike, who would be awaiting the results of a test.

The present invention provides, by the use of a rapidly cured ink/adhesive system, de-wicked sidewalls in a migration medium, which can be produced to accurate and repeatable dimension whereby toe provide migration paths for time-temperature liquids. The ink/adhesive employed to define the walls can be applied, in the limit to a thickness corresponding to the thickness of the migration medium. However, a convenient minimum width is 1.5 mm, which, in conjunction with a width of 6 mm or so for a channel, enables an easy to read time-temperature labelling system to be provided which can be readily and simply be repeatably manufactured. Ultraviolet-cured inks have been found to be superior to other forms of curing: infra-cured inks are susceptible to heating and thereby releasing certain organic volatile components which may be present and can affect one or more of the legibility of the reading (bubbles formed may hinder this) or the operating performance.

The migration channel conveniently vents to the atmosphere: ideally the migration channel, once out of the time/temperature range of indication upon the label continues around the label, whereby the time-temperature fluid does not leach out after the passage of further time, whereby the goods to which the label is attached does not become ruined by leakage of said fluid at a later date.

1-23. (canceled)

24. A time-temperature indicator comprising:
an indicator liquid reservoir;
a migration medium; and
a trigger;
wherein the trigger is operable to release an indicator liquid from the reservoir upon activation of the trigger into an entrance of a channel defined within the migration medium, wherein the extent of migration of indicator liquid from the trigger area through the channel can be determined by a change in color or brightness of the migration medium and is an indication of one or both of differences in temperature and a passage of time;
wherein the migration medium comprises a planar medium, having first and second major surfaces, which can absorb the indicator liquid;
wherein the channel is defined within the migration medium by a rapidly cured de-wicking ink and is defined at the surface of the first and second major planes of the migration medium by first and second impermeable lamination media; and
wherein at least one of the impermeable media is transparent such that a change in colour or brightness can be determined, as between a trigger area of the migration path and a distal portion of the migration channel.

25. The indicator of claim 24, wherein the liquid reservoir comprises a sachet of liquid, which is placed adjacent a trigger portion of the indicator, the sachet being arranged to release liquid upon activation of the trigger, whereby to cause the fluid to be absorbed by the migration medium.

26. The indicator of claim 24, wherein the de-wicking ink is an ink that is cured by radiation.

27. The indicator of claim 24, wherein the liquid reservoir is located on a face of one of the impermeable media opposite to the entrance of the defined channel, adjacent an area of the impermeable medium which is the trigger and is of a frangible nature whereby to enable passage of the liquid from a first side of the impermeable medium to the entrance of the channel upon activation of the trigger indicator.

28. The indicator of claim 24, wherein the volume defined between the migration medium and the trigger provides a volume to accept liquid from the liquid reservoir.

29. The indicator of claim 24, wherein the migration medium is selected from one of paper, felt, or cellulose fibre.

30. The indicator of claim 24, wherein the trigger comprises a rupturable seal between the reservoir and the entrance to the channel defined within the migration medium.

31. The indicator of claim 24, wherein the trigger comprises a rupturable seal between the reservoir and the entrance to the channel defined within the migration medium, which rupturable seal comprises one of a pressure rupturable seal, a heat-rupturable seal or an electrically-rupturable seal.

32. The indicator of claim 24, wherein the properties of the liquid and the migration medium are selected so that migration along the migration medium takes a predetermined time period at a predetermined temperature.

33. A process for manufacturing a time-temperature indicator, the process comprising the steps of:
(a) selecting a planar migration medium having first and second major planes;
(b) applying a de-wicking agent to define a migration path within the migration medium;
(c) allowing the de-wicking agent to cure;
(d) applying first and second impermeable media upon the first and second major planes whereby to define a migration channel closed to the upper face, lower face and sides and having an entry portion defined at one end of the migration path;
(e) providing a trigger about an area of one of the impermeable media adjacent said entry portion, which trigger is operable to allow a transfer of indicator fluid therethrough upon activation; and
(f) providing a liquid reservoir adjacent said trigger portion being positioned on an opposite side of said one of the impermeable media.

34. The method of claim 33, wherein the de-wicking agent is a solid ink and is cured upon radiation by an ultra-violet light source.

35. The method of claim 33, wherein the de-wicking agent is a solid ink and is cured upon radiation by an infra-red light source.

36. The method of claim 33, wherein the trigger portion being defined by one of a pressure/heat/electrically sensitive rupturable-frangible area, whereby the trigger activation can comprise the application of, respectively, pressure/heat/electric current.

37. An apparatus for manufacturing a time-temperature indicator, the time-temperature indicator comprising an indicator liquid reservoir, a migration medium and a trigger;
wherein the trigger is operable to release an indicator liquid from the reservoir upon activation of the trigger into an entrance of a channel defined within the migration medium, wherein the extent of migration of indicator liquid from the trigger area through the channel can be determined by a change in colour or brightness of the migration medium and is an indication of one or both of differences in temperature and a passage of time, the apparatus comprising:
a printing means, operable to print an ink upon a planar migration medium having first and second major planes, the ink being applied to define multiple units of time-temperature indicators, wherein the migration paths are defined;
a curing station, operable to cure the de-wicking ink;
first and second impermeable media lamination stations, operable to place first and second impermeable media upon the first and second major planes whereby to define a migration channel closed to the upper, lower and sides and having an entry portion defined at one end of the migration path;
a trigger defining station wherein a trigger is defined within an area of the one of the impermeable lamina; and
a liquid reservoir defining station operable to place a sachet of indicator fluid adjacent said trigger portion on a side of the impermeable lamina opposite said migration channel.

38. The apparatus of claim 37, wherein the de-wicking agent is a solid ink and is cured upon radiation by an ultra-violet light source and wherein the curing station is equipped with ultraviolet lamps.

39. The indicator of claim 24, wherein the properties of the liquid and the migration medium are selected so that migration along the migration medium takes a predetermined time period at a predetermined temperature, wherein the temperature is between −30° C. and +150° C.

40. The indicator of claim 24, wherein the liquid is a viscous liquid and the viscosity of the liquid controls the rate of liquid migration through the migration medium.

41. The indicator of claim 24, wherein the liquid is colored, whereby a colour change is produced in the migration medium by the migration of the liquid along the migration medium.

42. The indicator of claim 24, wherein the liquid contains a first reagent and the migration medium contains a second reagent which reacts with said first reagent, thereby producing the colour change.

43. The indicator of claim 24, wherein the liquid contains a first reagent and the migration medium contains a second reagent which reacts with said first reagent, thereby producing a colour change first to colour then to a second colour.
